(19) United States
(12) Patent Application Publication
(10) Pub. No.: US 2008/0308243 A1
(43) Pub. Date: Dec. 18, 2008

(54) Cationic Crosslinked Starch Containing Compositions and Use Thereof

(75) Inventors: Kevin R. Anderson, Cedar Rapids, IA (US); David E. Garlie, Eau Claire, WI (US)

Correspondence Address: PERKINS COIE LLP/CARGILL, INC., P.O. BOX 1247, SEATTLE, WA, 98111-1247, US

(73) Assignee: CARGILL, INCORPORATED, WAYZATA, MN (US)

(21) Appl. No.: 11/911,772

(22) PCT Filed: May 16, 2006
(86) PCT No.: PCT/US2006/018879

§ 371 Date: Aug. 5, 2008

(30) Foreign Application Priority Data
May 16, 2005 (US) 11/130382

(51) Int. Cl. C08L 3/02; D21H 25/00

(52) U.S. Cl. 162/175; 524/47

(57) ABSTRACT

There is disclosed a composition comprising at least one cationic crosslinked starch and an organic or inorganic component or a mixture thereof. Included within the organic compounds are any functionalized organic compound such as a polymerizable organic compound, a non-polymerizable organic compound, an organic polymer, or a mixture thereof. Included within the inorganic components are inorganic metals, or inorganic compounds. The compositions are suitable for various applications such as cellulosic products, coatings, paints, and the like. Also disclosed are processes for producing the compositions.

### FIELD OF THE DISCLOSURE

The present disclosure is directed to novel cationic crosslinked starch comprising compositions and the use thereof.

### BACKGROUND

It is well known that compositions of starches have been used in the production of various products as additives. For example, compositions of starches have been used in the production of paper products for purposes of economy, for sizing, and other purposes. It would therefore be desirable to provide new cationic crosslinked starch comprising compositions that will be useful in preparing various products. For example, the use of the new cationic crosslinked starch comprising compositions may improve the retention and drainage properties of the papermaking process, and may improve the strength of the resultant paper product. Furthermore, it is expected that use of the new cationic crosslinked starch comprising compositions may be useful in the preparation of coating compositions and paint compositions.

### SUMMARY OF THE DISCLOSURE

The present disclosure is directed to cationic crosslinked starch comprising compositions, and the use thereof in the preparation of cellulosic webs such as paper products, coating compositions, and paints. The starch compositions comprise from about 0.001 to about 99.999 weight percent of at least one cationic crosslinked starch, based upon total starch weight, and from about 0.001 to about 99.999 weight percent of at least one other organic or inorganic component, based upon total starch weight. The present disclosure is also directed to cellulosic webs, such as paper products, coating compositions, and paints, that are produced utilizing the starch compositions described herein.

### DETAILED DESCRIPTION OF THE DISCLOSURE

The present disclosure is directed to cationic crosslinked starch containing compositions, and the use thereof in the preparation of cellulosic webs such as paper products, coating compositions, and paints. The starch compositions comprise from about 0.001 to about 99.999 weight percent of at least one cationic crosslinked starch, based upon total starch weight, and from about 0.001 to about 99.999 weight percent of at least one other organic or inorganic component, based upon total starch weight. The starch compositions of the present disclosure are not inclusive of naturally occurring impurities, residual or otherwise. The present disclosure is also directed to cellulosic webs, such as paper products, coating compositions, and paints, that are produced utilizing the starch compositions described herein.

The starch compositions of the present disclosure in another embodiment comprise from about 1 to about 99 percent by weight cationic crosslinked starch and from about 1 to about 99 weight percent of at least one other organic or inorganic component. In another embodiment, the starch compositions comprise from about 5 to about 95 percent by weight cationic crosslinked starch and from about 5 to about 95 percent by weight of at least one other organic or inorganic component. In another embodiment, the starch compositions comprise from about 10 to about 90 percent by weight cationic crosslinked starch and from about 10 to about 90 percent by weight of at least one other organic or inorganic component. In another embodiment, the starch compositions comprise from about 20 to about 80 percent by weight cationic crosslinked starch and from about 20 to about 80 percent by weight of at least one other organic or inorganic component. In another embodiment, the starch compositions comprise from about 40 to about 60 percent by weight cationic crosslinked starch and from about 40 to about 60 percent by weight of at least one other organic or inorganic component.

In another embodiment of the present disclosure where the components of the composition comprise at least two cationic crosslinked starches, the amounts of the cationic crosslinked starches may be as follows. A first of the cationic crosslinked starches is present in an amount ranging from about 0.01 to 95 weight percent based on the composition, and a second of the cationic crosslinked starches is present in an amount ranging from 5 weight percent to about 99.99 weight percent of the composition. In this embodiment, preferably, the starch compositions comprise from about 10 to about 90 percent by weight a first cationic crosslinked starch and from about 10 to about 90 percent by weight a second cationic crosslinked starch.

In the present compositions, there may be utilized any cationic crosslinked starch. The starch may be derived from any suitable source such as dent corn starch, waxy corn starch, potato starch, wheat starch, rice starch, sago starch, tapioca starch, sorghum starch, sweet potato starch, and mixtures thereof.

In the compositions of the present disclosure, there is utilized at least one, or more, cationic crosslinked starch. In producing the cationic crosslinked starch, any conventional method may be used such as the following. A starch, as described herein, is cationized by reacting the starch with any cationizing agent. Exemplary of the cationizing agents are reagents having amino ions, imino ions, sulfonium ions, phosphonium ions, or ammonium ions and mixtures thereof. The cationizing reaction may be carried out in any conventional manner such as reacting the starch in an aqueous slurry form with the cationizing reagent, usually in the presence of an activating agent such as sodium hydroxide. Another process that may be used is a semi-dry process where the starch is reacted with the cationizing reagent in the presence of an activating agent such as sodium hydroxide, in a limited amount of water.

Examples of preferred cationizing agents are those having an ammonium ion, and more preferably, where the ammonium ion is a quaternary ammonium ion. A particularly useful cationizing agent is (3-chloro-2-hydroxypropyl)trimethylammonium chloride.

The starch, as described herein, is crosslinked by reacting the starch with any crosslinking agent. The reaction is carried out using any known manner for crosslinking a product. The crosslinking component, suitable for use herein, includes, but is not limited to, a multi-functional etherifying agent, a multi-functional esterifying agent, mixtures thereof, and the like. Specific examples of suitable crosslinking agents include, but are not limited to, epichlorohydrin, a dicarboxylic acid, phosphorous oxychloride, an alkali earth metal salt of trimetaphosphate, a phosphorous oxyanhydride that is a metal salt of a linear polyphosphate, a linear mixed anhydride, a polyamine polyepoxide resin, mixtures thereof, and the like. The crosslinking reaction may be carried out in any conventional manner such as reacting the starch in an aqueous slurry form with the crosslinking reagent usually in the presence of an activating agent such as sodium hydroxide. Another crosslinking process that may be used is a semi-dry process where the starch is reacted with the crosslinking reagent in the presence of an activating agent such as sodium hydroxide, in a limited amount of water.

The starch may be cationized and crosslinked in any order, in producing the cationic crosslinked starch. The cationizing agent and the crosslinking agent may be utilized in any order, including simultaneously.

The compositions of the present disclosure comprise a cationic crosslinked starch and at least one other organic or inorganic component.

In one embodiment, the component incorporated into the composition with a cationic crosslinked starch is an organic compound. Any organic compound is suitable for use in the compositions of the present disclosure. Typical of organic compounds that may be used herein include, but are not limited to, a functionalized organic compound, a polymerizable organic compound, a non-polymerizable organic compound, an organic polymer, or mixtures thereof.

Any functionalized organic compound, which includes polymerizable and non-polymerizable organic compounds, is suitable for use in the present compositions. Examples of functionalized organic compounds suitable for use include, but are not limited to, an alkane, an alkene, an araalkane, an araalkene, an alkyne, an araalkyne, an alcohol, an aldehyde, an acetal, a ketone, a ketal, a carboxylic acid, an acid halide, an ester, an anhydride, a peracid, an ether, a peroxide, a saccharide, a halide, an organosulfide, an organosulfone, an organosulfoxide, an organosulfite, an organosulfate, an organosulfonium salt, an organophosphine, an organophosphite, an organophosphate, an organophosphonite, an organophosphonate, an organophosphonium salt, an amine, a cyclic amine, an aminoacid, an imine, an amide, an amidine, a nitrile, an isocyanate, a nitrogen oxide, a nitrosamine, an organosilane, an organosiloxane, an intramolecular mixture thereof, and a mixture thereof.

Suitable for use herein are alkanes having linear, branched, or cyclic carbon chains of C₁ to C₅₀, alkenes having linear, branched, or cyclic carbon chains of C₁ to C₅₀, araalkanes having linear, branched, or cyclic carbon chains of C₁ to C₅₀, araalkenes having linear, branched, or cyclic carbon chains of C₁ to C₅₀, acetals having linear, branched, or cyclic carbon chains of C₁ to C₅₀, ketones having linear, branched, or cyclic carbon chains of C₁ to C₅₀, ketals having linear, branched, or cyclic carbon chains of C₁ to C₅₀, carboxylic acids having linear, branched, or cyclic carbon chains of C₁ to C₅₀, acid halides having linear, branched, or cyclic carbon chains of C₁ to C₅₀, esters having linear, branched, or cyclic carbon chains of C₁ to C₅₀, anhydrides having linear, branched, or cyclic carbon chains of C₁ to C₅₀, peracids having linear, branched, or cyclic carbon chains of C₁ to C₅₀, ethers having linear, branched, or cyclic carbon chains of C₁ to C₅₀, peroxides having linear, branched or cyclic carbon chains of C₁ to C₅₀, halides having linear, branched, or cyclic carbon chains of C₁ to C₅₀, organosulfides having linear, branched, or cyclic carbon chains of C₁ to C₅₀, organosulfones having linear, branched, or cyclic carbon chains of C₁ to C₅₀, organosulfoxides having linear, branched, or cyclic carbon chains of C₁ to C₅₀, organosulfites having linear, branched, or cyclic carbon chains of C₁ to C₅₀, organosulfates having linear, branched, or cyclic carbon chains of C₁ to C₅₀, organosulfonium salts having linear, branched, or cyclic carbon chains of C₁ to C₅₀, organophosphines having linear, branched, or cyclic carbon chains of C₁ to C₅₀, organophosphites having linear, branched, or cyclic carbon chains of C₁ to C₅₀, organophosphates having linear, branched, or cyclic carbon chains of C₁ to C₅₀, organophosphonites having linear, branched, or cyclic carbon chains of C₁ to C₅₀, organophosphonates having linear, branched, or cyclic carbon chains of C₁ to C₅₀, organophosphonium salts having linear, branched, or cyclic carbon chains of C₁ to C₅₀, amines having linear, branched, or cyclic carbon chains of C₁ to C₅₀, imines having linear, branched, or cyclic carbon chains of C₁ to C₅₀, amides having linear, branched, or cyclic carbon chains of C₁ to C₅₀, amidines having linear, branched, or cyclic carbon chains of C₁ to C₅₀, nitriles having linear, branched, or cyclic carbon chains of C₁ to C₅₀, isocyanates having linear, branched, or cyclic carbon chains of C₁ to C₅₀, nitrogen oxides having linear, branched, or cyclic carbon chains of C₁ to C₅₀, nitrosamines having linear, branched, or cyclic carbon chains of C₁ to C₅₀, organosilanes having linear, branched, or cyclic carbon chains of C₁ to C₅₀, organosiloxanes having linear, branched, or cyclic carbon chains of C₁ to C₅₀, inter- and intra-molecular mixtures thereof, and mixtures thereof.

Examples of alkenes include, but are not limited to ethylene, propylene, butylene, butadiene, ketenes including alkenyl ketene dimer (AKD), mixtures thereof, and the like.

Examples of alcohols include, but are not limited to methanol, ethanol, propanol, butanol, phenol, and sugar alcohols including, but not limited to, lactitol, erythritol, galactitol, glucitol, inositol, maltitol, sorbitol, xylitol, mixtures thereof, and the like.

Examples of aldehydes include, but are not limited to, formaldehyde, acetaldehyde, propionaldehyde, benzaldehyde, mixtures thereof, and the like.

Examples of ketones include, but are not limited to, acetone, methyl ethyl ketone, butanone, butenone, diones such as lactide, mixtures thereof, and the like.

Examples of carboxylic acids include, but are not limited to, adipic acid, citric acid, itaconic acid, lactic acid, propionic acid, benzoic acid, fatty acids such as palmitic acid, oleic acid, linoleic acid, linolenic acid, steric acid, mixtures thereof, and the like.

Examples of esters include, but are not limited to, methyl and ethyl esters of adipic acid, lactic acid, propionic acid, benzoic acid, palmitic acid, oleic acid, linoleic acid, linolenic acid, steric acid, acyl lipids such as triacylglycerols, phospholipids including lecithin, glycolipids, mixtures thereof, and the like.

Examples of amino acids include, alanine, arginine, asparagines, aspartic acid cysteine, glutamic acid, glutamine, glycine, isoleucine, leucine, lysine, methionine, phenylalanine, proline, serine, threonine, tyrosine, valine, peptide condensation products thereof, mixtures thereof, and the like.

Examples of anhydrides include, but are not limited to, succinic anhydride, octenyl succinic anhydride, alkenyl succinic anhydride (ASA), malic anhydride, maleic anhydride, mixtures thereof and the like.

Examples of saccharides include, but are not limited to, glucose, fructose, sucrose, galactose, maltose, isomaltose, lactose, levulose, maltitose, ribose, sorbose, trehalose, xylose, glucosamine, condensation products thereof, mixtures thereof, and the like.

Any organic polymer is suitable for use in preparing the compositions of the present disclosure. Included within the organic polymers are, but not limited to, synthetic polymers, natural polymers, and modified natural polymers. The organic polymer may have a linear, bridged, branched, or dendritic structure.

Suitable synthetic organic polymers include, but are not limited to, a polyolefin, a polystyrene, a polyacrylate, a polyacrylamide, a polycarbonate, a polyether, a polyester, a polysulfone, a polyamine, a polyamide, a polyimide, a polysilicone, a polysilane, a fluoropolymer, a vinyl polymer, an acrylic polymer, a vinyl acrylic interpolymer, a polyvinyl halide, a polyethylene oxide, a polyethersulfone, a polyisobutylene, a polyetheretherketone, a polyamideimide, a polyacrylonitrile, a polybutylene terephthalate, a polyisobutylene, a polyvinyl acetate, a polyvinyl amine, a polyvinyl alcohol, a polyoxyolefin, a polyhydroxyalkanoate, a polyurethane, a polysulfide, a polyacetal, a polyketal, a polyphenyleneoxide, a polyurea, a polyhydrazide, a resole, a urea-formaldehyde, a melamine-formaldehyde, a polycarbodiimide, an azo, a polyquinoxaline, a polypyrazine, a polypyrazole, a polyimidazole, a polytriazoline, a polyquinoline, a polypyrrole, a polyfuran, a polythiophene, a polyanhydride, a styrene-butadiene, a mixture thereof, and the like.

Suitable natural organic polymers include, but are not limited to, a polysaccharide, a protein, a polyamino acid, a polynucleic acid, a lignin, a polyisoprene, a rosin, a tall oil polymer, a mixture thereof, and the like.

Suitable examples of natural organic polymers are an agar, an alginate, an acacia gum, a gum arabic, a baobab mucilage, a carageenan, a cellulose, a chitin, a chitosan, a curdlan, a hemi-cellulose, a cyclodextrin, a dextran, a dextrin, a fenugreek gum, a glucan, a guar gum, a gum ghatti, a gum karaya, a gum tragacanth, a glycogen, a gellan, a konjac, a Jew's mellow, a Junsai mucilage, an inulin, a larch gum, a levan, a locust bean gum, an okra mucilage, a pectin, a polydextrose, a senna, a starch, a tara gum, a tamarind seed gum, a xanthan gum, a wellan, a mixture thereof, and the like.

Also suitable for use herein are modified natural organic polymers. The natural organic polymers may be modified by a chemical, physical, or enzymatic modification as defined herein.

Chemical modification includes any treatment of a natural organic polymer with a chemical that results in a modified natural organic polymer. Within chemical modification are included, but not limited to, depolymerization, oxidation, reduction, etherification, esterification, nitrification, defatting, and the like. Chemically modified natural organic polymers may also be prepared by using a combination of any of the chemical treatments. Examples of chemically modified natural organic polymers include the reaction of octenyl succinic anhydride with starch to produce a hydrophobic esterified starch; the reaction of 2,3-epoxypropyltrimethylammonium chloride with starch to produce a cationic starch; the reaction of ethylene oxide with cellulose to produce hydroxyethyl cellulose; the reaction of hypochlorite with starch to produce an oxidized starch; the reaction of an acid with starch to produce an acid depolymerized starch; defatting of a starch with a solvent such as methanol, ethanol, propanol, methylene chloride, chloroform, carbon tetrachloride, and the like, to produce a defatted protein.

Physically modified natural organic polymers are any natural organic polymers that are physically treated in any manner to provide physically modified natural organic polymers. Within physical modification are included, but not limited to, thermal treatment, pressure treatment, combinations of any of the physical treatments, and the like. Examples of physical modifications include thermal treatment of starch in the presence of water, thermal treatment of starch in the absence of water, thermal treatment of protein in the absence of water, thermal treatment of protein in the presence of water, pressure treatment of starch to melt the starch granules, thermal treatment of starch in an aqueous environment to cause the starch granules to swell without granule rupture, the thermal treatment of anhydrous starch granules to cause polymer rearrangement, fragmentation of the starch granules by mechanical disintegration, and pressure treatment of starch granules by means of an extruder to cause melting of the starch granules.

Enzymatically modified natural organic polymers are any natural organic polymers that are enzymatically treated in any manner to provide enzymatically modified natural organic polymers. Examples of enzymatic modification include, but not limited to, the reaction of an alpha amylase with starch, the reaction of a protease with starch, the reaction of a protease with protein, the reaction of a lipase with starch, the reaction of a phosphorylase with starch, the reaction of an oxidase with starch, the reaction of an oxidase with cellulose, the reaction of a cellulase with cellulose, and the like. Combinations of the enzymatic treatments may be utilized.

The organic polymer may have any structure such as a linear, bridged, branched, dendritic structure, or the like. Where the organic polymer has a dendritic structure, the structure may be selected from a dendrimer, a dendron, a dendrigraft, or a mixture thereof. Where the organic polymer is a dendrimer, the structure may have a hyperbranched dendritic structure. Where the organic polymer is a dendrigraft, the structure may have a hyperbranched dendritic structure.

Any inorganic component may be used in preparing compositions of the present disclosure. The inorganic component used herein may be an inorganic metal or an inorganic compound. Preferably, the inorganic compound utilized in the present compositions is a salt, and even more preferably, is a metal salt.

The inorganic metal that is suitable for use in preparing the present compositions is selected from an element of Group I A, Group II A, Group III A, Group IV A, Group V A, Group I B, Group II B, Group III B, Group IV B, Group V B, Group VI B, Group VII B, Group VIII B, and a mixture thereof. Examples of Group II A metals include magnesium, examples of Group III A metals include aluminum, examples of Group IV A metals include tin and lead, examples of Group V A metals include antimony, examples of Group VI A metals include sulfur, examples of Group I B metals include copper, silver, and gold, examples of Group II B metals include zinc, examples of Group IV B metals include titanium and zirconium, examples of Group VI B metals include tungsten, examples of Group VII B metals include manganese, examples of Group VIII B metals include iron, nickel, palladium, and platinum.

The inorganic compound utilized in the preparation of the present composition may be any inorganic compound. For example, there may be used as the inorganic compound any inorganic salt. In addition, there may be utilized as the inorganic compound materials that are not inorganic salts. For example, materials that are not inorganic salts may include, but are not limited to, non-ionic metal oxides, such as silicon dioxide, titanium dioxide, iron oxide, zinc oxide, hydrogen peroxide, and the like, and non-ionic metal halides such as silicon tetrachloride, titanium tetrachloride, aluminum tetrachloride, zinc chloride, and the like.

The metal of the inorganic compounds is selected from an element of Group I A, Group II A, Group III A, Group IV A, Group V A, Group I B, Group II B, Group III B, Group IV B, Group V B, Group VI B, Group VII B, Group VIII B, and a mixture thereof. For example, where the inorganic compound comprises an element of Group I A, the element may be selected from lithium, sodium, potassium, and a mixture thereof; where the inorganic compound comprises an element of Group II A, the element may be selected from beryllium, magnesium, calcium, and a mixture thereof; where the inorganic compound comprises an element of Group III A, the element may be selected from aluminum, gallium, indium, and a mixture thereof; where the inorganic compound comprises an element of Group IV A, the element may be selected from germanium, tin, lead, and a mixture thereof; where the inorganic compound comprises an element of Group V A, the element may be selected from antimony, bismuth, and a mixture thereof; where the inorganic compound comprises an element of group I B, the element may be selected from copper, silver, gold, and a mixture thereof; where the inorganic compound comprises an element of Group II B, the element may be selected from zinc, cadmium, mercury, and a mixture thereof; where the inorganic compound comprises an element of Group IV B, the element may be selected from titanium, zirconium, and a mixture thereof; where the inorganic compound comprises an element of Group VI B, the element may be selected from chromium, molybdenum, tungsten, and a mixture thereof; where the inorganic compound comprises an element of Group VII B, the element may be selected from the group consisting of manganese, technetium, rhenium, and a mixture thereof; and where the inorganic compound comprises an element of Group VIII B, the element may be selected from iron, cobalt, nickel, palladium, platinum, and a mixture thereof.

Suitable for use herein as inorganic compounds are, but limited to, the following:

Inorganic metal salts comprising an ion selected from an oxide ion, a halide ion, a hydride ion, a hydroxide ion, mixtures thereof, and the like. Typical of the metal salts comprising an ionic oxide include, are but not limited to, a metal carbon oxide, a metal silicon oxide, a metal phosphorous oxide, a metal sulfur oxide, a metal nitrogen oxide, a metal boron oxide, an metal oxygen oxide, mixtures thereof, and the like. For example, there may be used metal carbonates such as calcium carbonate, a metal aluminosilicate such as sodium aluminosilicate, a metal phosphate such as sodium trimetaphosphate, and a metal sulfate such as calcium sulfate, and mixtures thereof, and the like.

Suitable inorganic compounds for use in preparing the present compositions include metal salts that comprise an ionic halide. The ionic halide may be selected from a carbon halide, a silicon halide, a phosphorous halide, a sulfur halide, a nitrogen halide, a boron halide, an oxygen halide, a mixture thereof, and the like.

Suitable inorganic compounds for use in preparing the present compositions include metal salts comprising an ionic hydride. The hydride may be selected from a silicon hydride, a phosphorous hydride, a sulfur hydride, a boron hydride, a mixture thereof, and the like.

Suitable inorganic compounds for use in preparing the present compositions include metal salts that comprise an ionic hydroxide. The hydroxide may be selected from a silicon hydroxide, a phosphorous hydroxide, a sulfur hydroxide, a nitrogen hydroxide, a boron hydroxide, an oxygen hydroxide, a mixture thereof, and the like.

Suitable inorganic compounds for use in preparing the present compositions include salts that comprise an ion selected from an ammonium ion, a sulfonium ion, a phosphonium ion, a mixture thereof, and the like.

Suitable inorganic compounds for use in preparing the present compositions include salts that comprise an ionic silicate. Typical of the salts is a sodium aluminosilicate. In another embodiment the ionic silicate may comprise at least one phosphate group. In another embodiment the ionic silicate may comprise at least one sulfate group.

Suitable inorganic compounds for use herein include a salt that comprises an ionic aluminum oxide.

Suitable inorganic compounds for use herein include a salt that comprises an ionic phosphate.

Suitable inorganic compounds for use herein include an inorganic polymer. The inorganic polymer may be selected from a polysulfur nitride, a polysiloxane, a polysilazane, a polysilane, a phosphonitrilic, a carborane, a polyphosphozine, an aromatic polyphosphate, a polyborozine, a mixture thereof, and the like.

In producing the starch compositions of the present disclosure, any conventional method may be used for mixing the components of the composition. For example, each of the components of the composition may be in dry form when mixed together. Alternately, each of the components of the composition may be in slurry form when mixed together to form the composition. Alternately, one of the components may be in dry form, and one of the components may be in slurry form, when the components are mixed together to form a starch composition. Alternately, one of the components may be in solution and one of the components in any form such as dry, slurry, or solution.

Another acceptable method of mixing in any manner, is to utilize at least one or more gelatinized starch pastes after the starch suspensions have been gelatinized by a cooking process.

In an alternative embodiment, a starch blend of the present disclosure comprising cationic crosslinked starch components may be prepared in the following manner. Unmodified starch components are mixed to provide a composition of unmodified starch components. Thereafter, the blend of unmodified starch components is cationized and crosslinked to produce a composition of starch components, each of which is cationized and crosslinked.

Alternatively, in another embodiment, the starch compositions may be produced by mixing the components of the composition. Thereafter, the resultant mixture is heated to form a gelatinization paste mixture in which the starch is gelatinized at a temperature typically above about 90° C. The resultant gelatinized paste mixture is subsequently dried to remove substantially all moisture. Optionally, the dried mixture is thereafter ground to a powder. An advantage resulting from the process is that the need for gelatinizing starch at the paper production facility is removed.

Alternatively, in another embodiment, the starch compositions may be produced by combining a gelatinized starch paste of the cationic crosslinked starch component with the other component of the composition. The resultant gelatinized paste mixture is subsequently dried to remove substantially all moisture. Optionally, the dried mixture is thereafter ground to a powder. An advantage resulting from the process is that the need for gelatinizing starch to be used in producing paper is removed.

In carrying out the above two processes the drying may be achieved in any manner. For example, there may be utilized a drum dryer, a spray dryer, a thin film wipe dryer, a turbo reactor, a fluidize bed dryer, and the like.

The starch compositions of the present disclosure may include any conventional additives. For example, there may be incorporated dyes, pigments, sizing additives, retention and drainage aids, aqueous suspensions or solutions of biopolymers or synthetic polymers, and the like.

The cationic crosslinked starch compositions of the present disclosure are useful in the production of paper. The starch compositions of the present disclosure may be incorporated in the production of paper using any conventional manner. For example, the cationic crosslinked starch compositions may be slurried in water and the resultant slurry heated at a temperature sufficient to achieve gelatinization of the starch slurry to produce a gelatinized starch paste. Typically, the heating to achieve gelatinization is carried out at a temperature above about 90° C. The resultant gelantinized starch paste is then mixed with the other component of the composition. The gelatinized starch paste composition may then be introduced into a cellulosic suspension, particularly a paper furnish, in any known manner. In doing so, the gelatinized starch paste composition may be introduced at the wet-end of a paper machine in a paper fiber thick stock, or a paper fiber thin stock, or a split addition to both the thick stock and thin stock. In introducing the gelatinized starch paste composition to the cellulosic suspension, any amount of starch composition may be incorporated as desired. Typically, the amount of starch composition to be incorporated ranges from about 0.1% to about 5% by weight based on the paper fiber. In a preferred embodiment, the starch composition is present in an amount ranging from about 0.5% to about 2% by weight based on the weight of the fiber.

It has been found that incorporation of the starch compositions of the present disclosure in the production of paper, results in increased retention and improved drainage of the paper furnish. These properties are generally recognized in the art as being useful for enhancing the papermaking process. Furthermore, it is expected that incorporation of the starch compositions of the present disclosure in the production of paper, will result in paper products having higher internal bond strength.

In addition, the starch compositions of the present disclosure are utilized in the preparation of coatings that preferably may be applied to paper. The starch compositions of the present disclosure may be used as a binder in the production of paper coating formulations. Preferably, the starch component of the compositions is in a gelatinized form when utilized in the preparation of the paper coatings. Typically, paper coating formulations comprise a pigment such as clay, calcium sulfate, or calcium carbonate; a binder such as latex, polyvinyl alcohol, starch, or protein; and various other additives such as lubricants, insolubilizers, rheology modifiers, optical brighteners, water retention aids, dispersants, biocides, dyes, and the like. It is expected that use of the novel starch compositions of the present disclosure in paper coatings will impart improved hydrophobicity, improved ink holdout, and improved printing properties to the coated product. Furthermore, the use of the starch compositions in coatings is expected to impart improved rheology to the coating color, and impart a bulky structure to the dried coating. Preferably, the coating is applied to a paper product. In addition, the coating of the present disclosure may be utilized as a paint.

Typically, in the production of the present coatings there is utilized a pigment in an amount of about 100 parts. The binder component of the coating is typically utilized in an amount of about 1 to about 50 parts, more typically about 5 to about 20 parts, based on the pigment. Any other ingredients such as lubricants, rheology modifiers, water retention agents, or the like, that are desired in the coating may be utilized in well known conventional amounts, such as 0.5 parts based on the pigment.

The coatings incorporating the novel starch compositions may be applied to a surface, such as that of a cellulosic web, in any conventional manner. Typically, the coating may be applied to a surface by the use of a roll coater, a rod coater, a blade coater, a film press coater, an air knife coater, a curtain coater, a spray coater, and the like. It is expected that the coatings incorporating the novel starch compositions may be particularly useful in the area of curtain coating.

It is also expected that the cationic crosslinked starch compositions of the present disclosure would have utility in fields other than papermaking and paints. Such applications would include, for example, food container manufacture, flocculation of aqueous suspensions as in water treatment and ore purification, and the like.

The following examples are presented to illustrate the present invention and to assist one of ordinary skill in making and using the same. The examples are not intended in any way to otherwise limit the scope of the invention.

### EXAMPLES

The following test procedures are utilized in evaluating the properties of the starch compositions and the paper products provided in the examples.

### Test Procedures

### Paper Furnish Drainage Rate

The Paper Furnish Drainage Rate analysis was performed on a Dynamic Drainage Analyzer (DDA) manufactured by AB Akribi Kemikonsulter, Hogalidsgatan 26 S-856 31 Sundsvall, Sweden. The procedure utilized in evaluating the paper furnish drainage rate performance is fully described in the manual (version 3.xx, March 2003) for operating the Dynamic Drainage Analyzer provided by the manufacturer. In carrying out the evaluation, the procedure was utilized under the following generalized conditions:

### Rotor Speed—750 rpm

Vacuum Setting—225 bars

### Sample Volume—800 ml

Start Rotor—As specified in Examples
Make starch and other additive additions as specified
Drain—at 0 seconds
Record drainage rate

### Paper Furnish Retention Value

The paper furnish retention value was performed by measuring turbidity of the filtrate generated from the Paper Furnish Drainage Rate test from above. Turbidity was measured using a Model 2100P Portable Turbidimeter Instrument, available through the HACH COMPANY, following the instructions contained in the corresponding manual for the 2100P. The filtrate sample was removed from the Dynamic Drainage Apparatus soon after the drainage rate determination and 15 ml placed in the measuring vial for the 2100P. The turbidity was measured and recorded as Nephelometric Turbidity Units (NTU). The NTU values have an inverse relationship to Paper Furnish Retention in that the lower the NTU, the better the Paper Furnish Retention.

### Internal Bond Strength

Internal Bond Strength of Paper (Scott Bond)—TAPPI Test Procedure T 541 om-89

### Starch Compositions

### Example 1

This example illustrates the preparation of a composition containing crosslinked cationic starch and a chemically modified natural organic polymer.

A 440 g dry basis sample of ALTRA CHARGE 145 cationic crosslinked dent corn starch, available from CARGILL, INC., was slurried in water to prepare a 5% starch suspension. 4.4 g of cationic gum guar 2-hydroxy-3-(trimethylammonio)-propyl ether chloride available from ALDRICH, was added to the suspension and stirred for 10 minutes. The suspension was then jet cooked at 230° F. in a pilot jet cooker at a flow rate of 1 liter/minute with a retention time of 30 seconds, to provide a 99:1 cooked starch paste/cationic gum guar composition.

An evaluation of the paper furnish drainage rate and retention characteristics of the cooked paste composition was carried out. The procedure for determining paper furnish drainage rate and retention is described herein. The samples measured are prepared by adding the cooked paste composition to the paper furnish. The samples are described as amount of starch paste added, calculated on a dry basis, per ton of paper fiber. The results obtained are reported in the following TABLE 1. The paper furnish composition was as follows:

### Test Stock Consistency—0.53%

Test Stock Composition—36% hardwood, 19% softwood, 25% high ash broke, 13% low ash broke, 6% precipitated calcium carbonate, 1% ground calcium carbonate

In determining the paper drainage rate and retention values, the test sequence of the DDA was as follows:

| | Addition | |
|---|---|---|
| Sequence | (lbs/ton) | Time (Seconds) |
| Start rotor | | 45 |
| Starch | As Shown | 30 |
| Silica | 4.2 | 10 |
| Coagulant | 1.3 | 5 |
| Drain | | 0 |

TABLE 1
Paper Furnish Drainage Rate and Retention

| | Paper Furnish Drainage | Paper Furnish |
|---|---|---|
| Starch Paste/Guar | Rate | Retention |
| Addition (lb/ton) | (Seconds) | (Turbidity NTU) |
| 0 (Control) | 8.9 | 1393 |
| 10 | 4.7 | 230 |
| 15 | 5.1 | 227 |
| 20 | 6.7 | 200 |
| 25 | 7.3 | 198 |
| 30 | 8.1 | 213 |

In view of the data in Table 1 it is observed that for a given starch addition, the paper furnish drainage rate and retention, where the compositions of the current disclosure are used, improves as compared with the control. It is expected that the improved paper furnish drainage rate would lead to faster paper machine operation. It is also expected that the improved paper furnish retention values would lead to more efficient paper machine operation.

### Example 2

This example illustrates the preparation of a composition containing crosslinked cationic starch and a chemically modified natural organic polymer.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to provide a cooked paste. To the stirring cooked paste was added 200 g of a 2% suspension of bleached kraft hardwood cellulose fiber to give a 90:10 dry solids basis composition. The mixing was continued for 5 minutes after the cellulose fiber was added. The cooked paste/fiber composition was poured onto a plastic drying tray, which was then placed in a forced air oven set at 65° C. and dried overnight. The dried film was ground to a fine powder with a laboratory grinder.

### Example 3

This example illustrates the preparation of a composition containing crosslinked cationic starch and a chemically modified natural organic polymer.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 20 g of a 10% solution of carboxymethylcellulose (CMC) to give a 95:5 dry solids basis composition. The cooked paste/CMC composition was poured onto a plastic drying tray, which was then placed in a forced air oven set at 65° C. and dried overnight. The dried film was ground to a fine powder with a laboratory grinder.

### Example 4

This example illustrates the preparation of a composition containing crosslinked cationic starch and a chemically modified natural organic polymer.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 200 g of a 2% suspension of bleached kraft softwood cellulose fiber to give a 90:10 dry solids basis composition. The mixing was continued for 5 minutes after the cellulose fiber was added. The cooked paste/fiber composition was poured onto a plastic drying tray, which was then placed in a forced air oven set at 65° C. and dried overnight. The dried film was ground to a fine powder with a laboratory grinder. The samples were evaluated for paper furnish drainage and retention characteristics and the results are reported in Table 2.

### Example 5

This example illustrates the preparation of a composition containing crosslinked cationic starch and a chemically modified natural organic polymer.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. To this was added 40 g of a 5% suspension of an sulfuric acid treated seed based corn fiber having a cellulose content of 68% and a hemicellulose content of 10% to give a 95:5 dry solids basis composition. The beaker was placed in a boiling water bath and an overhead stirrer was placed in the suspension for mixing. The suspension was covered with aluminum foil, then cooked for 20 minutes with mixing at 1300 rpm to give a cooked paste. The cooked paste/fiber composition was poured onto a plastic drying tray, which was then placed in a forced air oven set at 65° C. and dried overnight. The dried film was ground to a fine powder with a laboratory grinder. The samples were evaluated for paper furnish drainage and retention characteristics and the results are reported in Table 2.

### Example 6

This example illustrates the preparation of a composition containing crosslinked cationic starch and a chemically modified natural organic polymer.

A 40 g dry basis sample of ALTRA CHARGE 140 cationic crosslinked dent corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 200 g of a 2% suspension of bleached kraft softwood cellulose fiber to give a 90:10 dry solids basis composition. The mixing was continued for 5 minutes after the cellulose fiber was added. The cooked paste/fiber composition was poured onto a plastic drying tray, which was then placed in a forced air oven set at 65° C. and dried overnight. The dried film was ground to a fine powder with a laboratory grinder.

### Example 7

This example illustrates the preparation of a composition containing crosslinked cationic starch and a chemically modified natural organic polymer.

A 40 g dry basis sample of ALTRA CHARGE 140 cationic crosslinked dent corn starch, available from CARGILL, INC., was slurried in a 1 liter stainless steel beaker with 376 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the rapidly stirring cooked paste was added 500 g of a 4% suspension of bleached kraft softwood cellulose fiber to give a 50:50 dry solids basis composition. The mixing was continued for 5 minutes after the cellulose fiber was added. The cooked paste/fiber composition was poured onto a plastic drying tray, which was then placed in a forced air oven set at 65° C. and dried overnight. The dried film was ground to a fine powder with a laboratory grinder.

### Example 8

This example illustrates the preparation of a composition containing crosslinked cationic starch and a natural organic polymer.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 2 g of a xanthan gum in a dry form to give a 95:5 dry solids basis composition. The mixing was continued for 5 minutes after the xanthan gum was added. The sample was removed from the water bath and the cooked paste composition poured onto a plastic drying tray, which was then placed in a forced air oven set at 65° C. and dried overnight. The dried film was ground to a fine powder with a laboratory grinder.

### Example 9

This example illustrates the preparation of a composition containing crosslinked cationic starch and an inorganic metal salt.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 18 g of a 55% suspension of calcium carbonate to give a 75:25 dry solids basis composition. The mixing was continued for 5 minutes after the calcium carbonate was added. The sample was removed from the water bath and the cooked paste composition poured onto a plastic drying tray, which was then placed in a forced air oven set at 65° C. and dried overnight. The dried film was ground to a fine powder with a laboratory grinder. The samples were evaluated for paper furnish drainage rate and retention characteristics and the results are reported in Table 2. The paper furnish composition was as follows:

### Test Stock Consistency—0.40%

Test Stock Composition—45% hardwood, 20% softwood, 30% broke, 5% precipitated calcium carbonate

In determining the paper drainage rate and retention values for Examples 4, 5, and 9, the test sequence of the DDA was as follows:

| | Addition | Time |
|---|---|---|
| Sequence | (lbs/ton) | (Seconds) |
| Start rotor | | 30 |
| PAC | 5 | 20 |
| Starch | As Shown | 10 |
| Silica | 1.5 | 5 |
| Drain | | 0 |

The paper furnish drainage rate and retention values for Examples 4, 5, and 9 are reported in Table 2.

TABLE 2
Paper Furnish Drainage Rate

| Starch Paste | Starch Paste | Paper Furnish | Paper Furnish |
|---|---|---|---|
| Products | Addition | Drainage Rate | Retention |
| of Example No. | (lbs/ton) | (seconds) | (Turbidity NTU) |
| Blank Control | 0 | 18.6 | 278 |
| 4 | 10 | 13.91 | 68 |
| | 15 | 10.79 | 60 |
| | 20 | 8.44 | 38 |
| | 25 | 8.41 | 51 |
| 5 | 10 | 15.54 | 148 |
| | 15 | 12.14 | 85 |
| | 20 | 9.39 | 40 |
| | 25 | 8.66 | 35 |
| 9 | 10 | 14.65 | 84 |
| | 15 | 10.39 | 58 |
| | 20 | 8.09 | 33 |
| | 25 | 7.61 | 32 |

In view of the data in Table 2 it is observed that for a given starch addition, the paper furnish drainage rate, where the compositions of the current disclosure are used, improves as compared with the control. It is expected that the improved paper furnish drainage rate would lead to faster paper machine operation and that the improved paper furnish retention values would lead to more efficient paper machine operation.

### Example 10

This example illustrates the preparation of a composition containing crosslinked cationic starch and a natural organic polymer.

A 2 g sample of chitosan was suspended in 188 g of de-ionized water. With mixing, 1 ml of concentrated phosphoric acid was added dropwise to the suspension. After about 2 hours, the chitosan had dissolved to a slightly yellow clear solution. A 40 g dry basis sample of ALTRA CHARGE 340 cationic crosslinked waxy corn starch, available from CARGILL, INC., was slurried in a 400 ml beaker fitted with a magnetic stir bar in 60 ml of deionized water to give a 40% dry solids suspension. The 1% chitosan solution was added to the ALTRA CHARGE 340 suspension and stirred for 30 minutes at 40° C. The pH of the suspension was adjusted from 2.6 to a pH of 4.6 with 2% sodium hydroxide solution and the suspension vacuum filtered on a Buchner funnel and dried to give a 95:5 composition.

### Example 11

This example illustrates the preparation of a composition containing crosslinked cationic starch and a synthetic polymer.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 36 g of a 11.1% solution of Polyvinylamine/Polyvinylformamide polymer (PVAm), hydrolyzed to 50%, to give a 90:10 dry solids basis composition. The mixing was continued for 5 minutes after the PVAm was added. The sample was removed from the water bath and the cooked paste composition poured onto a plastic drying tray, which was then placed in a forced air oven set at 65° C. and dried overnight. The dried film was ground to a fine powder with a laboratory grinder. The samples were evaluated for paper furnish retention characteristics and the results are reported in Table 3.

### Example 12

This example illustrates the preparation of a composition containing crosslinked cationic starch and a synthetic organic polymer.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 0.4 g of poly(DL-lactide), available from ALDRICH, to give a 99:1 dry solids basis composition. The mixing was continued for 5 minutes after the poly(DL-lactide) was added. The sample was removed from the water bath and the cooked paste composition poured onto a plastic drying tray, which was then placed in a forced air oven set at 65° C. and dried overnight. The dried film was ground to a fine powder with a laboratory grinder.

### Example 13

This example illustrates the preparation of a composition containing crosslinked cationic starch and a synthetic organic polymer that is also a salt.

A 40 g dry basis sample of ALTRA CHARGE 340 cationic crosslinked waxy corn starch, available from CARGILL, INC., is slurried in a 1 liter stainless steel beaker with 756 ml of deionized water to give a 5% dry solids suspension. The beaker is placed in a boiling water bath and an overhead stirrer was placed in the suspension for mixing. The suspension is covered with aluminum foil, then cooked for 20 minutes with mixing at 1300 rpm to give a cooked paste. To the stirring cooked paste is added 0.2 g of poly(vinyl sulfate, potassium salt), available from ALDRICH, to give a 99.5:0.5 dry solids basis composition. The mixing is continued for 5 minutes after the poly(vinyl sulfate, potassium salt) was added. The sample is removed from the water bath and the cooked paste composition poured onto a plastic drying tray, which is then placed in a forced air oven set at 65° C. and dried overnight. The dried film is ground to a fine powder with a laboratory grinder. The samples were evaluated for paper furnish retention characteristics and the results are reported in Table 3.

### Example 14

This example illustrates the preparation of a composition containing crosslinked cationic starch and a functionalized organic compound.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 0.8 g of adipic acid, available from FISHER SCIENTIFIC, to give a 98:2 dry solids basis composition. The mixing was continued for 5 minutes after the adipic acid was added. The sample was removed from the water bath and the cooked paste composition poured onto a plastic drying tray, which was then placed in a forced air oven set at 65° C. and dried overnight. The dried film was ground to a fine powder with a laboratory grinder.

### Example 15

This example illustrates the preparation of a composition containing crosslinked cationic starch and a synthetic organic polymer.

A 40 g dry basis sample of ALTRA CHARGE 340 cationic crosslinked waxy corn starch, available from CARGILL, INC., is slurried in a 1 liter stainless steel beaker with 756 ml of de-ionized water to give a 5% dry solids suspension. The beaker is placed in a boiling water bath and an overhead stirrer was placed in the suspension for mixing. The suspension is covered with aluminum foil, then cooked for 20 minutes with mixing at 1300 rpm to give a cooked paste. To the stirring cooked paste is added 0.4 g of COMPOZIL PL 1610 cationic polyacrylamide polymer, available from EKA CHEMICALS, to give a 99:1 dry solids basis composition. The mixing is continued for 5 minutes after the polymer was added. The sample is removed from the water bath and the cooked paste composition poured onto a plastic drying tray, which is then placed in a forced air oven set at 65° C. and dried overnight. The dried film is ground to a fine powder with a laboratory grinder. The samples were evaluated for paper furnish retention characteristics and the results are reported in Table 3.

### Example 16

This example illustrates the preparation of a composition containing crosslinked cationic starch and an organic compound that is also a salt.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 0.4 g of tetrabutylammonium chloride, available from ALDRICH, to give a 99:1 dry solids basis composition. The mixing was continued for 5 minutes after the tetrabutylammonium chloride was added. The sample was removed from the water bath and the cooked paste composition poured onto a plastic drying tray, which was then placed in a forced air oven set at 65° C. and dried overnight. The dried film was ground to a fine powder with a laboratory grinder. The samples were evaluated for paper furnish retention characteristics and the results are reported in Table 3.

### Example 17

This example illustrates the preparation of a composition containing crosslinked cationic starch and an inorganic compound.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 2 g of titanium(IV) oxide powder, available from ALDRICH, to give a 95:5 dry solids basis composition. The mixing was continued for 5 minutes after the titanium(IV) oxide powder was added. The sample was removed from the water bath and the cooked paste composition poured onto a plastic drying tray, which was then placed in a forced air oven set at 65° C. and dried overnight. The dried film was ground to a fine powder with a laboratory grinder.

### Example 18

This example illustrates the preparation of a composition containing crosslinked cationic starch and an organic compound.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 1.2 g of glyceryl tributyrate, available from ALDRICH, to give a 97:3 dry solids basis composition. The mixing was continued for 5 minutes after the glyceryl tributyrate was added. The sample was removed from the water bath and the cooked paste composition poured onto a plastic drying tray, which was then placed in a forced air oven set at 65° C. and dried overnight. The dried film was ground to a fine powder with a laboratory grinder.

### Example 19

This example illustrates the preparation of a composition containing crosslinked cationic starch and an inorganic compound.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 0.8 g of silica gel, grade 645, available from ALDRICH, to give a 98:2 dry solids basis composition. The mixing was continued for 5 minutes after the silica gel was added. The sample was removed from the water bath and the cooked paste composition poured onto a plastic drying tray, which was then placed in a forced air oven set at 65° C. and dried overnight. The dried film was ground to a fine powder with a laboratory grinder.

### Example 20

This example illustrates the preparation of a composition containing crosslinked cationic starch and an inorganic compound.

A 40 g dry basis sample of ALTRA CHARGE 340 cationic crosslinked waxy corn starch, available from CARGILL, INC., was slurried in a 1 liter stainless steel beaker with 756 ml of de-ionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 1.4 g of a 58% solids suspension of NUCLAY delaminated clay, available from Engelhard, to give a 98:2 dry solids basis composition. The mixing was continued for 5 minutes after the delaminated clay was added. The sample was removed from the water bath and the cooked paste composition poured onto a plastic drying tray, which was then placed in a forced air oven set at 65° C. and dried overnight. The dried film was ground to a fine powder with a laboratory grinder.

### Example 21

This example illustrates the preparation of a composition containing crosslinked cationic starch and an organic compound.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 3.2 g of dodecyldimethylamine, available from Aldrich, to give a 92:8 dry solids basis composition. The mixing was continued for 5 minutes after the dodecyldimethylamine was added. The sample was removed from the water bath and the cooked paste composition poured onto a plastic drying tray, which was then placed in a forced air oven set at 65° C. and dried overnight. The dried film was ground to a fine powder with a laboratory grinder.

### Example 22

This example illustrates the preparation of a composition containing crosslinked cationic starch and a chemically modified natural organic polymer.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 4.5 g of SUPER FILM 270 oxidized starch, available from CARGILL, INC., to give a 90:10 dry solids basis composition. The mixing was continued for 5 minutes after the oxidized starch was added. The sample was removed from the water bath and the cooked paste composition poured onto a plastic drying tray, which was then placed in a forced air oven set at 65° C. and dried overnight. The dried film was ground to a fine powder with a laboratory grinder. The samples were evaluated for paper furnish retention characteristics and the results are reported in Table 3.

### Example 23

This example illustrates the preparation of a composition containing crosslinked cationic starch and a chemically modified natural organic polymer.

There was provided a cooked cationic crosslinked starch paste having a Brookfield (Model DV-II+) viscosity of 165 cps as measured at 65° C., with a spindle 21 at 20 rpm. With this was mixed, in a 50:50 ratio, a second cationic crosslinked starch paste having a Brookfield viscosity of 85 cps as measured at 65° C., with a spindle 21 at 20 rpm. The two starches were prepared by jet cooking, but at different temperature conditions. The cooked paste composition poured onto a plastic drying tray, which was then placed in a forced air oven set at 65° C. and dried overnight. The dried film was ground to a fine powder with a laboratory grinder. The samples were evaluated for paper furnish retention characteristics and the results are reported in Table 3. The paper furnish composition was as follows:

### Test Stock Consistency—0.35%

Test Stock Composition—80% hardwood, 20% softwood, 30% precipitated calcium carbonate

In determining the retention values for Examples 11, 13, 15, 16, 22, and 23, the test sequence of the DDA was as follows:

| | Addition | Time |
|---|---|---|
| Sequence | (lbs/ton) | (Seconds) |
| Start rotor | | 30 |
| Starch | As Shown | 10 |
| Drain | | 0 |

The paper furnish retention values for Examples 11, 13, 15, 16, 22, and 23 are reported in Table 3.

TABLE 3
Paper Furnish Retention

| Starch Paste | Starch Addition | Paper Furnish |
|---|---|---|
| Products of | Level | Retention |
| Example No. | (lbs/ton) | (NTU) |
| Blank | 0 | 720 |
| 11 | 5 | 135 |
| | 10 | 136 |
| | 20 | 115 |
| 13 | 5 | 155 |
| | 10 | 101 |
| | 20 | 102 |
| 15 | 5 | 200 |
| | 10 | 99 |
| | 20 | 78 |
| 16 | 5 | 133 |
| | 10 | 102 |
| | 20 | 98 |
| 22 | 5 | 176 |
| | 10 | 154 |
| | 20 | 179 |
| 23 | 5 | 150 |
| | 10 | 145 |
| | 20 | 159 |

In view of the data in Table 3 it is observed that for a given starch composition addition, the paper furnish retention values, where the compositions of the current disclosure are used, improves as compared with the control. It is expected that the improved paper furnish retention values would lead to more efficient paper machine operation.

### Example 24

This example illustrates the preparation of a composition containing crosslinked cationic starch and an inorganic polymer.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 4 g of polyaluminum chloride polymer, to give a 90:10 dry solids basis composition. The mixing was continued for 5 minutes after the polyaluminum chloride polymer was added. The sample was removed from the water bath and the cooked paste composition poured onto a plastic drying tray, which was then placed in a forced air oven set at 65° C. and dried overnight. The dried film was ground to a fine powder with a laboratory grinder.

### Example 25

This example illustrates the preparation of a composition containing crosslinked cationic starch and an inorganic metal.

A 40 g dry basis sample of ALTRA CHARGE 340 cationic crosslinked waxy corn starch, available from CARGILL, INC., is slurried in a 1 liter stainless steel beaker with 756 ml of de-ionized water to give a 5% dry solids suspension. The beaker is placed in a boiling water bath and an overhead stirrer was placed in the suspension for mixing. The suspension is covered with aluminum foil, then cooked for 20 minutes with mixing at 1300 rpm to give a cooked paste. To the stirring cooked paste is added 0.04 g of aluminum powder, available from ALDRICH, to give a 99.9:0.01 dry solids basis composition. The mixing is continued for 5 minutes after the aluminum powder was added. The sample is removed from the water bath and the cooked paste composition poured onto a plastic drying tray, which is then placed in a forced air oven set at 65° C. and dried overnight. The dried film is ground to a fine powder with a laboratory grinder.

### Example 26

This example illustrates the preparation of a composition containing crosslinked cationic starch and a polymerizable organic compound.

A 40 g dry basis sample of ALTRA CHARGE 340 cationic crosslinked waxy corn starch, available from CARGILL, INC., is slurried in a 1 liter stainless steel beaker with 756 ml of deionized water to give a 5% dry solids suspension. The beaker is placed in a boiling water bath and an overhead stirrer is placed in the suspension for mixing. The suspension is covered with aluminum foil, then cooked for 20 minutes with mixing at 1300 rpm to give a cooked paste. To the stirring cooked paste is added 0.4 g of acrylic acid, to give a 99:1 dry solids basis composition. The mixing is continued for 5 minutes after the acrylic acid is added. The sample is removed from the water bath and the cooked paste composition poured onto a plastic drying tray, which is then placed in a forced air oven set at 65° C. and dried overnight. The dried film is ground to a fine powder with a laboratory grinder.

### Example 27

This example illustrates the preparation of a composition containing crosslinked cationic starch and an inorganic metal salt.

A 40 g dry basis sample of ALTRA CHARGE 340 cationic crosslinked waxy corn starch, available from CARGILL, INC., is slurried in a 1 liter stainless steel beaker with 756 ml of deionized water to give a 5% dry solids suspension. The beaker is placed in a boiling water bath and an overhead stirrer is placed in the suspension for mixing. The suspension is covered with aluminum foil, then cooked for 20 minutes with mixing at 1300 rpm to give a cooked paste. To the stirring cooked paste is added 0.8 g of aluminum sulfate, to give a 98:2 dry solids basis composition. The mixing is continued for 5 minutes after the aluminum sulfate is added. The sample is removed from the water bath and the cooked paste composition poured onto a plastic drying tray, which is then placed in a forced air oven set at 65° C. and dried overnight. The dried film is ground to a fine powder with a laboratory grinder.

### Example 28

This example illustrates the preparation of a composition containing crosslinked cationic starch and an organic compound that is also a salt.

A 40 g dry basis sample of ALTRA CHARGE 340 cationic crosslinked waxy corn starch, available from CARGILL, INC., was slurried in a 1 liter stainless steel beaker with 756 ml of deionized water to give a 5% dry solids suspension. The beaker was placed in a boiling water bath and an overhead stirrer was placed in the suspension for mixing. The suspension was covered with aluminum foil, then cooked for 20 minutes with mixing at 1300 rpm to give a cooked paste. To the stirring cooked paste was added 0.4 g of tetrabutylammonium chloride, available from ALDRICH, to give a 99:1 dry solids basis composition. The mixing was continued for 5 minutes after the tetrabutylammonium chloride was added. The sample was removed from the water bath and the cooked paste composition poured onto a plastic drying tray, which was then placed in a forced air oven set at 65° C. and dried overnight. The dried film was ground to a fine powder with a laboratory grinder.

### Example 29

This example illustrates the preparation of a composition containing crosslinked cationic starch and an organic polymer having a dendritic structure.

A 40 g dry basis sample of ALTRA CHARGE 340 cationic crosslinked waxy corn starch, available from CARGILL, INC., is slurried in a 1 liter stainless steel beaker with 756 ml of deionized water to give a 5% dry solids suspension. The beaker is placed in a boiling water bath and an overhead stirrer is placed in the suspension for mixing. The suspension is covered with aluminum foil, then cooked for 20 minutes with mixing at 1300 rpm to give a cooked paste. To the stirring cooked paste is added 0.4 g of PAMAM Dendrimer, generation 5 with primary amino groups on the surface, available from ALDRICH, to give a 99:1 dry solids basis composition. The mixing is continued for 5 minutes after the PAMAM Dendrimer, generation 5, is added. The sample is removed from the water bath and the cooked paste composition poured onto a plastic drying tray, which is then placed in a forced air oven set at 65° C. and dried overnight. The dried film is ground to a fine powder with a laboratory grinder.

### Example 30

This example illustrates the preparation of a composition containing crosslinked cationic starch and an inorganic metal salt.

A 40 g dry basis sample of MICROCAT 330 cationic crosslinked tapioca starch, available from NATIONAL STARCH & CHEMICAL COMPANY, is slurried in a 1 liter stainless steel beaker with 756 ml of deionized water to give a 5% dry solids suspension. The beaker is placed in a boiling water bath and an overhead stirrer is placed in the suspension for mixing. The suspension is covered with aluminum foil, then cooked for 20 minutes with mixing at 1300 rpm to give a cooked paste. To the stirring cooked paste is added 2 g of sodium dihydrogen phosphate, to give a 95:5 dry solids basis composition. The mixing is continued for 5 minutes after the sodium dihydrogen phosphate is added. The sample is removed from the water bath and the cooked paste composition poured onto a plastic drying tray, which is then placed in a forced air oven set at 65° C. and dried overnight. The dried film is ground to a fine powder with a laboratory grinder.

The disclosure has been described with reference to various specific and illustrative embodiments and techniques. However, one skilled in the art will recognize that many variations and modifications may be made while remaining within the spirit and scope of the disclosure.

What is claimed is:

1. A composition comprising from about 0.001% to about 99.999% of a cationic crosslinked starch.

2. The composition according to claim 1, wherein the starch is selected from the group consisting of: dent corn starch, waxy corn starch, potato starch, tapioca starch, wheat starch, rice starch, sago starch, sorghum starch, sweet potato starch, and mixtures thereof.

3. The composition according to claim 1, wherein the starch is cationized by reacting the starch with a component selected from the group consisting of an amino ion, imino ion, sulfonium ion, phosphonium ion, ammonium ion, and mixtures thereof.

4. The composition according to claim 3, wherein the component is an ammonium ion containing compound that is a quaternary ammonium ion containing compound.

5. The composition according to claim 4, wherein the quaternary ammonium ion containing compound is (3-chloro-2-hydroxypropyl)trimethylammonium chloride.

6. The composition according to claim 1, wherein the starch is crosslinked by reacting the starch with a component selected from the group consisting of a multi-functional etherifying agent, a multi-functional esterifying agent, and a mixture thereof.

7. The composition according to claim 6, wherein the multi-functional etherifying agent is selected from the group consisting of an organohalide, an organosulfate, an organosulfonate, an organophosphate, an organophosphonate, an organoisocyanate, an organoazide, an aldehyde, a ketone, an epoxide, an alkene, an alkyne, an intramolecular mixture thereof, and a mixture thereof.

8. The composition according to claim 6, wherein the multi-functional esterifying agent is selected from the group consisting of a carboxylic acid, an anhydride, an ester, an acid halide, a phosphorous oxyhalide, a phosphorous oxyanhydride, a sulfuryl halide, an intramolecular mixture thereof, and a mixture thereof.

9. The composition according to claim 1, further comprising a component selected from the group consisting of an organic compound, an inorganic metal, an inorganic compound, and a mixture thereof.

10. The composition according to claim 9, wherein the component is an organic compound that is a functionalized organic compound.

11. The composition according to claim 9, wherein the component is an organic compound selected from the group consisting of an alkane, an alkene, an araalkane, an araalkene, an alkyne, an araalkyne, an alcohol, an aldehyde, an acetal, a ketone, a ketal, a carboxylic acid, an acid halide, an ester, a peracid, an ether, a peroxide, a saccharide, a halide, an organosulfide, an organosulfone, an organosulfoxide, an organosulfite, an organosulfate, an organosulfonium salt, an organophosphine, an organophosphite, an organophosphate, an organophosphonite, an organophosphonate, an organophosphonium salt, an amine, a cyclic amine, an aminoacid, an imine, an amide, an amidine, a nitrile, an isocyanate, a nitrogen oxide, a nitrosamine, an organosilane, an organosiloxane, an intramolecular mixture thereof, and a mixture thereof.

12. The composition according to claim 9, wherein the component is an organic compound selected from the group consisting of a polymerizable organic compound, a non-polymerizable organic compound, an organic polymer, and a mixture thereof.

13. The composition according to claim 12, wherein the non-polymerizable organic compound is selected from the group consisting of an alkane, an alkene, an araalkane, an araalkene, an alkyne, an araalkyne, an alcohol, an aldehyde, an acetal, a ketone, a ketal, a carboxylic acid, an acid halide, an ester, a peracid, an ether, a peroxide, a saccharide, a halide, an organosulfide, an organosulfone, an organosulfoxide, an organosulfite, an organosulfate, an organosulfonium salt, an organophosphine, an organophosphite, an organophosphate, an organophosphonite, an organophosphonate, an organophosphonium salt, an amine, a cyclic amine, an aminoacid, an imine, an amide, an amidine, a nitrile, an isocyanate, a nitrogen oxide, a nitrosamine, an organosilane, an organosiloxane, an intramolecular combination thereof, and a mixture thereof.

14. The composition according to claim 12, wherein the polymerizable organic compound is selected from the group consisting of an alkene, an araalkane, an araalkene, an alkyne, an araalkyne, an alcohol, an aldehyde, an acetal, a ketone, a ketal, a carboxylic acid, an acid halide, an ester, a peracid, an ether, a peroxide, a saccharide, a halide, an organosulfide, an organosulfone, an organosulfoxide, an organosulfite, an organosulfate, an organosulfonium salt, an organophosphine, an organophosphite, an organophosphate, an organophosphonite, an organophosphonate, an organophosphonium salt, an amine, a cyclic amine, an aminoacid, an imine, an amide, an amidine, a nitrile, an isocyanate, a nitrogen oxide, a nitrosamine, an organosilane, an organosiloxane, an intramolecular mixture thereof, and a mixture thereof.

15. The composition according to claim 12, wherein the organic polymer is selected from the group consisting of a synthetic organic polymer, a natural organic polymer, a modified natural organic polymer, an intramolecular mixture thereof, and a mixture thereof.

16. The composition according to claim 15, wherein the organic polymer is a synthetic organic polymer selected from the group consisting of a polyolefin, a polystyrene, a polyacrylate, a polyacrylamide, a polycarbonate, a polyether, a polyester, a polysulfone, a polyamine, a polyamide, a polyimide, a polysilicone, a polysilane, a fluoropolymer, a vinyl polymer, an acrylic polymer, a vinyl acrylic interpolymer, a polyvinyl halide, a polyethylene oxide, a polyethersulfone, a polyisobutylene, a polyetheretherketone, a polyamideimide, a polyacrylonitrile, a polybutylene terephthalate, a polyisobutylene, a polyvinyl acetate, a polyvinyl amine, a polyvinyl alcohol, a polyoxyolefin, a polyhydroxyalkanoate, a polyurethane, a polysulfide, a polyacetal, a polyketal, a polyphenyleneoxide, a polyurea, a polyhydrazide, a resole, a urea-formaldehyde, a melamine-formaldehyde, a polycarbodimide, an azo, a polyquinoxaline, a polypyrazine, a polypyrazole, a polyimidazole, a polytriazoline, a polyquinoline, a polypyrrole, a polyfuran, a polythiophene, a polyanhydride, a styrene-butadiene, and a mixture thereof.

17. The composition according to claim 15, wherein the organic polymer is a natural organic polymer selected from the group consisting of a polysaccharide, a protein, a polyamino acid, a polynucleic acid, a lignin, a polyisoprene, a rosin, a tall oil polymer, and a mixture thereof.

18. The composition according to claim 17, wherein the natural organic polymer is a polysaccharide selected from the group consisting of an agar, an alginate, an acacia gum, a gum arabic, a baobab mucilage, a carageenan, a cellulose, a chitin, a chitosan, a curdlan, a hemi-cellulose, a cyclodextrin, a dextran, a dextrin, a fenugreek gum, a glucan, a guar gum, a gum ghatti, a gum karaya, a gum tragacanth, a glycogen, a gellan, a konjac, a Jew's mellow, a Junsai mucilage, an inulin, a larch gum, a levan, a locust bean gum, an okra mucilage, a pectin, a polydextrose, a senna, a starch, a tara gum, a tamarind seed gum, a xanthan gum, a wellan, and a mixture thereof.

19. The composition according to claim 12, wherein the organic polymer has a linear, bridged, branched, or dendritic structure.

20. The composition according to claim 19, wherein the organic polymer has a dendritic structure and is selected from the group consisting of a dendrimer, a dendron, a dendrigraft, and a mixture thereof.

21. The composition according to claim 20, wherein the organic polymer is a dendrimer having a hyperbranched dendritic structure.

22. The composition according to claim 20, wherein the organic polymer is a dendrigraft having a hyperbranched dendritic structure.

23. The composition according to claim 9, wherein the inorganic metal is selected from the group consisting of Group I A, Group II A, Group III A, Group IV A, Group V A, Group I B, Group II B, Group III B, Group IV B, Group V B, Group VI B, Group VII B, Group VIII B, and a mixture thereof.

24. The composition according to claim 9, wherein the inorganic compound comprises an ion selected from the group consisting of an oxide ion, a halide ion, a hydride ion, a hydroxide ion, and a mixture thereof.

25. The composition according to claim 24, wherein the metal salt comprises an oxide ion selected from the group consisting of a carbon oxide ion, a silicon oxide ion, a phosphorous oxide ion, a sulfur oxide ion, a nitrogen oxide ion, a boron oxide ion, an oxygen oxide ion, and a mixture thereof.

26. The composition according to claim 24, wherein the inorganic compound comprises a halide ion selected from the group consisting of a carbon halide ion, a silicon halide ion, a phosphorous halide ion, a sulfur halide ion, a nitrogen halide ion, a boron halide ion, an oxygen halide ion, and a mixture thereof.

27. The composition according to claim 24, wherein the metal salt comprises a hydride ion selected from the group consisting of a silicon hydride ion, a phosphorous hydride ion, a sulfur hydride ion, a boron hydride ion, and a mixture thereof.

28. The composition according to claim 24, wherein the inorganic compound comprises a hydroxide ion selected from the group consisting of a silicon hydroxide ion, a phosphorous hydroxide ion, a sulfur hydroxide ion, a nitrogen hydroxide ion, a boron hydroxide ion, an oxygen hydroxide ion, and a mixture thereof.

29. The composition according to claim 9, wherein the inorganic compound is an inorganic polymer.

30. The composition according to claim 29, wherein the inorganic polymer is selected from the group consisting of a polysulfur nitride, a polysiloxane, a polysilazane, a polysilane, a phosphonitrilic, a carborane, a polyphosphozine, an aromatic polyphosphate, a polyborozine, and a mixture thereof.

31. A cellulosic web product comprising a cellulosic web and from about 0.01% by weight to about 99.99% by weight of the composition according to claim 1, wherein the starch is present in an amount of from about 0.01% by weight to about 99.99% by weight.

32. The cellulosic web product according to claim 31 wherein the cellulosic web is selected from the group consisting of paper and paperboard.

33. The cellulosic web product according to claim 31, wherein the composition comprises a component selected from the group consisting of an organic compound, an inorganic metal, an inorganic compound, and a mixture thereof.

34. The cellulosic web product according to claim 33, wherein the organic compound is an organic polymer.

35. A process for preparing a cellulosic web product comprising incorporating into a cellulosic web from about 0.01% to about 99.9% by weight of a composition comprising from about 0.01% to about 99.99% of a cationic crosslinked starch.

36. A coating composition comprising a pigment and a composition comprising from about 0.01% to about 99.99% of a cationic crosslinked starch.

37. The coating composition according to claim 36 wherein the composition is present in an amount of from about 1 to about 50 parts based on the pigment.

38. The coating composition according to claim 36, wherein the composition comprises a component selected from the group consisting of an organic compound, an inorganic metal, an inorganic compound, and a mixture thereof.

39. The coating composition according to claim 38, wherein the organic compound is an organic polymer.

40. A cellulosic web product comprising a cellulosic web coated with the coating composition according to claim 36.

41. A paint comprising the coating composition according to claim 36.

42. A paint comprising the coating composition according to claim 38.

43. A paint comprising the coating composition according to claim 39.

44. A process for producing the composition according to claim 1 comprising mixing components of the composition, heating the resultant mixture to form a gelatinized cationic crosslinked starch paste mixture, in which the starch is gelatinized, and drying the resultant gelatinized starch paste mixture.

45. A process for producing the composition according to claim 1 comprising combining a gelatinized cationic crosslinked starch paste component with another component of the composition to form a gelatinized starch paste mixture, and drying the resultant gelatinized starch paste mixture.
